(19) United States
(12) Patent Application Publication
(10) Pub. No.: US 2025/0224324 A1
(43) Pub. Date: Jul. 10, 2025

(54) POROSITY MEASUREMENT USING A GALLIUM-BASED INTRUDING AGENT

(71) Applicant: Anton Paar GmbH, Graz (AT)

(72) Inventors: Denis SCHÜTZ, Graz (AT); Bernhard NELL, Graz (AT)

(21) Appl. No.: 18/880,533

(22) PCT Filed: May 19, 2023
(86) PCT No.: PCT/EP2023/063461

§ 371 Date: Dec. 31, 2024

(30) Foreign Application Priority Data
Jul. 1, 2022 (DE) 10 2022 116 546.9

(51) Int. Cl. G01N 15/08

(52) U.S. Cl. CPC G01N 15/088; G01N 15/0806; G01N 2015/0813

(57) ABSTRACT

There is described an apparatus for determining an information indicative of a porosity of a sample, the apparatus comprising:
i) a measurement chamber, configured to accommodate the sample to be measured;
ii) an intruding agent reservoir, configured to provide the intruding agent to the measurement chamber;
iii) a pressure device, configured to apply a pressure profile to the measurement chamber, so that the intruding agent is pressed into at least part of the pores of the sample; and
iv) a determination device, configured to determine the information indicative of the porosity of the sample based on the measured pressure.

The intruding agent comprises gallium or a gallium alloy, and the apparatus is configured to provide reducing or inert conditions with respect to the intruding agent.

### CROSS-REFERENCE TO RELATED APPLICATIONS

The present application is a U.S. National Phase Patent Application of International Patent Application Number PCT/EP2023/063461, filed on May 19, 2023, which claims priority to German Patent Application Number 10 2022 116 546.9, filed on Jul. 1, 2022, the entire content of each of the two applications is incorporated herein by reference.

### FIELD OF THE DISCLOSURE

The disclosure relates to an apparatus for determining an information indicative of a porosity of a sample. Further, the disclosure relates to a method of determining the information, e.g. using the apparatus. Furthermore, the disclosure relates to a use of gallium or a gallium alloy as an intruding agent in a porosity measurement.

Thus, the disclosure may relate to the technical field of measurement technology, in particular porosity measurements.

### TECHNICAL BACKGROUND

A plurality of materials comprises pores and, accordingly, a measurable porosity. The porosity is a measure of the void (empty) spaces in a material, and can be expressed for example as the volume fraction of voids over the total volume of the material, e.g. in percent. The porosity of a material can be an important or even crucial information in many technical fields, for example pharmaceutics, ceramics, metallurgy, material science, mechanical engineering, geology, hydrology, etc.

Several measurement techniques have been developed to measure the porosity of a sample, for example optical measurement (e.g. using a microscope), tomography measurement (e.g. CT scanning), water evaporation measurement, gas expansion measurement, and mercury intrusion measurement.

Mercury intrusion may be seen as the most common and economically most important porosity measurement. The technique involves the intrusion of a non-wetting liquid (i.e. mercury) at high pressure into a material within a porosimeter. The pore size can be determined based on the external pressure applied to force the mercury into the pores against the opposing force of the liquid's surface tension. In particular, the pore size determination is done using the Washburn equation. Further, mercury intrusion (and extrusion) measurements can also determine further pore-related properties such as pore diameter, total pore volume, and surface areas.

The primary measured quantities are the volume of intruded mercury volume and the corresponding applied pressure. In addition, when the pressure is reversed, especially in high-pressure mercury porosimetry, the extruded mercury volume can be measured.

However, the application of mercury has several drawbacks. Mercury is toxic and environmentally harmful, so that a costly recycling process for the used mercury is mandatory. Further, the used mercury may not be suitable for recycling within a porosity measurement apparatus, due to the toxicity of mercury vapors.

### SUMMARY OF THE DISCLOSURE

There may be a need to perform a porosity measurement in a cost-efficient and environmental/health-friendly manner.

An apparatus, a method, and a use are provided.

According to a first aspect of the disclosure, there is described an apparatus (in particular a liquid (intrusion) porosimeter) for determining an information indicative of a porosity of a sample, the apparatus comprising:
i) a measurement chamber (in particular a penetrometer), configured to accommodate the sample to be measured;
ii) an intruding agent reservoir, configured to (store the intruding agent and to) provide the intruding agent to the measurement chamber (measurement chamber and intruding agent reservoir may be (directly) coupled);
iii) a pressure device (e.g. a piston providing pressure to the measurement chamber), configured to apply a pressure profile to the measurement chamber, so that the intruding agent is pressed into at least part of the pores of the sample;
(the apparatus) in particular comprising a measurement device (e.g. a capacitive measurement, inductive measurement, optical measurement, etc.), configured to measure a volume and/or a pressure related to the provided pressure profile); and
iv) a determination device (e.g. a control device), configured to determine the information indicative of the porosity of the sample based on the measured pressure profile (e.g. using the Washburn equation) and/or the (intrusion/extrusion) volume of the intruding agent.

The intruding agent (is gallium-based, i.e. it) comprises or consists of gallium or a gallium alloy. The apparatus is configured to provide reducing conditions (e.g. using a reducing agent such as an acid) and/or inert conditions (e.g. store/transport in an inert gas) with respect to the intruding agent.

According to a second aspect of the disclosure, there is described a method of determining an information indicative of a porosity of a sample, the method comprising:
i) providing an intruding agent to the sample to be measured, wherein the intruding agent comprises gallium or a gallium alloy;
ii) applying a pressure profile, so that the intruding agent is pressed into at least a part of the pores of the sample;
(the method in particular comprises measuring a pressure related to the pressure profile and/or the (intrusion/extrusion volume of the intruding agent)
iii) determining the information indicative of the porosity of the sample based on the pressure profile and/or the volume of the intruding agent.

The method further comprises:
iv) providing reducing or inert conditions with respect to the intruding agent.

According to a third aspect of the disclosure, there is described a use (method of using) gallium or a gallium alloy as an intruding agent in a porosimeter, wherein oxidation of the intruding agent (in particular to gallium oxide) is prevented by providing reducing conditions and/or inert conditions.

In the context of the present document, the term “reducing conditions” may in particular refer to conditions in a specific region that favor a chemical reduction reaction (in contrast to an oxidation reaction). A reduction reaction may be a type of chemical reaction in which the oxidation states of atoms are changed. In particular, redox reactions may be characterized by the actual or formal transfer of electrons between chemical species, most often with one species (the reducing agent) undergoing oxidation (losing electrons) while another species (the oxidizing agent) undergoes reduction (gains electrons). An example for reducing conditions in the present document may be the provision of a reducing agent at the surface of the intruding agent (e.g. in the intruding agent reservoir or in the measurement chamber). For example, the reducing agent may be configured as an acid such as hydrochloric acid that prevents the formation of gallium oxide and/or chemically reacts with gallium oxide (Ga₂O₃) to the corresponding soluble gallium salt (e.g. gallium chloride (GaCl₃) for HCl). In this manner, the reducing conditions may prevent the formation and/or the existence of gallium oxide.

In the context of the present document, the term “inert conditions” may in particular refer to conditions in a specific region that prevent a chemical reaction, in particular an oxidation reaction. Inert substances (in particular fluids) may not undergo chemical reactions under a set of given conditions. In an example, a noble gas such as argon is provided as an inert fluid to protect the intruding agent (e.g. in the intruding agent reservoir and/or in the measurement chamber) from oxidation. The inert fluid may be a cleaning gas and/or a working fluid, so that it may be used for both, providing inert conditions for the intruding agent, and fulfilling a specific task for the porosity measurement.

In the context of the present document, the term “pressure profile” may in particular refer to a pre-defined pressure change over time applied to the measurement chamber. The pressure may force the intruding agent (due to its surface tension not entering pores under normal conditions) into the pores. The necessary pressure may depend on the size of the pores. The pressure may be applied during the pressure profile in a continuous or step-wise pressure increase manner. In an example, the pressure profile is applied in two steps: a low-pressure measurement and a high-pressure measurement, in particular using different working fluids.

In the context of the present document, the term “intruding agent” may in particular refer to a substance (in particular a fluid) suitable to be introduced into the pores of a sample under an applied pressure. Such an intruding agent may be preferably a non-wetting fluid that is essentially liquid at measurement conditions. Further, the intruding agent should be non-reactive with the sample. The common example of an intruding agent in porosimetry may be mercury. Nevertheless, a gallium-based intruding agent may be a surprisingly efficient substitute.

According to an exemplary embodiment, the disclosure may be based on the idea that a porosity measurement can be performed in a cost-efficient and environmental/health-friendly manner, when mercury is replaced as an intruding agent by a gallium-based agent, and when said gallium-based intruding agent is protected against oxidation (within the measurement apparatus environment) by providing inert conditions and/or reducing conditions.

Gallium and gallium alloys comprise physical/chemical properties comparable to mercury and aluminum. Like mercury, gallium (alloys) can be liquid at measurement conditions and are thereby non-wetting liquids. In comparison to mercury, gallium or gallium alloys may have the advantage that they are neither toxic nor environmentally harmful. Recycling gallium (alloys) in the context of porosity measurements may be done more efficiently, so that on the one hand cost can be saved, while on the other hand no environment/health-disturbing wastes may be produced, which can be a large cost factor. In particular, because the current legislation requires to use specifically equipped hazard rooms to work with mercury.

Nevertheless, gallium (alloys) have a strong drawback in comparison to mercury, so that they have not been considered as a substitute so far: gallium may be easily oxidized to gallium oxide (in particular Ga₂O₃), the later not being a non-wetting liquid (specifically, it is a dispersion of solid gallium oxide at the surface that is making the liquid wettable, whereby this solid is then dissolved/reduced; it will remain on top for cohesion/density surface tension reasons), and thereby hampering or even impede porosity measurements (for example by adhering to the measurement chamber, in particular the penetrometer column).

It has now been surprisingly found by the inventors, that gallium (and gallium alloys) can nevertheless be applied in a highly efficient manner in intrusion porosity measurements, when specific means are implemented that prevent the oxidation of gallium in the measurement environment. Said specific means include in particular the provision of reducing or inert conditions. Specific implementations of these conditions are described for the following exemplary embodiments.

Gallium (alloys) may further comprise a larger contact angle in comparison to mercury, so that it may intrude larger pores at the same pressure in comparison to mercury. Further, gallium is less dense than mercury (half its density roughly), therefore, in addition to the contact angle, the hydrostatic pressure is substantially lower (and therefore the largest measurable pore is substantially larger). Thus, even more accurate measurements may be enabled using gallium (alloys).

Furthermore, the described approach may be directly implemented into existing porosity measurement systems, thereby enabling a straightforward application.

### EXEMPLARY EMBODIMENTS

According to an embodiment, the gallium alloy comprises at least one metal of the group which consists of indium, tin, zinc, potassium, sodium, copper, silver, cesium, bismuth, antimony, lead, gold, thallium, palladium, platinum, selenium, lithium, cadmium. In particular, the gallium alloy comprises at least one of the group which consists of GaIn, GaInSn, GaZn, GaInZn. This may provide the advantage that an established and industry-relevant gallium alloy can be directly applied as the intruding agent. GaIn consists for example of Ga 75.5% and In 24.5% and is liquid at room temperature. GaInSn (brand name Galinstan®) is an eutectic alloy being liquid at room temperature. GaInSn comprises a low toxicity and low reactivity, so that it may be well suitable to replace mercury. In a very specific example, the gallium alloy may comprise KNa, rubidium, or francium.

In an example, every gallium alloy that is liquid at measurement conditions (in particular room temperature) may be suitable.

According to a further embodiment, the inert conditions comprise a protection of the intruding agent at least partially by an inert fluid (in particular an inert gas). An inert fluid may be applied to (e.g. located on top of) the intruding agent in the apparatus. For example, the intruding agent reservoir, wherein the intruding agent is stored, can be partially filled with the inert fluid. In a further example, the inert fluid can be streamed into the measurement chamber and protect the intruding agent therein against oxidation. Additionally, the intruding agent may be streamed through supply lines of the apparatus together with the inert fluid. In this manner, an efficient protection against oxidation may be provided.

In an example, the inert fluid is chosen from one of the group, which consists of a noble gas (in particular argon), nitrogen, carbon monoxide (can also be a reducing agent). In an example, the inert fluid may be used as a cleaning fluid that cleans the intruding agent and/or the (parts of the) apparatus. In a further example, the inert fluid may be used as a working fluid.

According to a further embodiment, the reducing conditions comprise an application of a reducing agent (to the intruding agent). While the inert fluid (see above) provides inert conditions for the intruding agent, a reducing agent (or reducing fluid) can provide reducing conditions that prevent oxidation and/or reduce oxidized (intruding agent) substances such as gallium oxide. Additionally or alternatively to the inert fluid, the reducing fluid may be provided to the intruding agent in the apparatus, for example in the intruding agent reservoir, the measurement chamber, and/or the supply lines. In this manner, an efficient protection against oxidation may be provided.

According to a further embodiment, the reducing agent comprises a gallium oxide dissolving fluid. This may provide the advantage that oxidized gallium substances (in particular gallium oxide) are efficiently reduced (removed), thereby recycling the intruding agent. According to a further embodiment, the reducing agent is applied as a fluid to a surface and/or a phase border of the intruding agent. In this manner, the reducing conditions can be directly provided to the intruding agent, especially, during storage of the intruding agent (in the reservoir). Further, also in the measurement chamber, the reducing agent may cover the surface of the intruding agent. In a specific embodiment (see FIG. 6), in the measurement chamber, the intruding agent is covered with the reducing agent, which is in turn further covered by an inert (cleaning) fluid (gas).

According to a further embodiment, the reducing agent comprises a chemically active substance such as an acid or a base. In a specific example, at least one of hydrochloric acid, sulfuric acid, phosphoric acid, acetic acid, and nitric acid is used. In another example, a base such as sodium hydroxide (NaOH) or potassium hydroxide (KOH) is applied.

According to a further embodiment, the intruding agent reservoir is configured to store the intruding agent and to provide the inert fluid and/or the reducing agent to the stored intruding agent. Thereby, inert/reducing conditions may be provided directly and efficiently to the stored intruding agent.

According to a further embodiment, the intruding agent reservoir is configured to cover the surface of the stored intruding agent, in particular so that the inert fluid and/or the reducing fluid floats on the intruding agent. In this manner, the surface of the intruding agent may be efficiently protected against oxygen and oxidizing substances.

According to a further embodiment, the determination device is further configured to determine the information indicative of the porosity of the sample using the Washburn equation. This may provide the advantage that an established evaluation scheme can be directly applied. While in other techniques, evaluation of the porosity may take place using image analysis or magnetic resonance, the described method may apply a pressure profile that is evaluated in context of measured pressure (and intruding agent volume) using the established Washburn equation.

According to a further embodiment, the apparatus is further configured to provide a cleaning fluid (for example the inert fluid) and/or the reducing agent to at least part of the apparatus and/or to the intruding agent before the measurement and/or after the measurement (for example within the intruding agent reservoir). While the cleaning fluid rather provides inert conditions, the reducing agent is configured to provide reducing conditions. The described apparatus may be designed to protect the intruding agent against oxidation at different locations and in different manners. Accordingly, a plurality of combinations is possible in an actual implementation. This in turn increases the design flexibility.

According to a further embodiment, the apparatus is configured to recover used intruding agent by the reducing agent. In particular, during the measurement, the intruding agent may become at least partially oxidized and may be recovered by the reducing agent.

According to a further embodiment, the measurement chamber is cleaned before the measurement. In an example, there can be applied: rinsing and brushing (with reducing fluid), rinsing with a cleaning solution (e.g. an alcohol such as isopropyl), drying with pressurized air. In particular example, it may be advantageous to remove all high-pressure working fluid (oil) after a high-pressure measurement form the measurement chamber.

According to a further embodiment, a cleaning step (e.g. with the cleaning fluid) may help to remove oxygen/oxidizing agents from the measurement chamber/apparatus, in particular by further using a vacuum pump.

According to a further embodiment, the (recovered) intruding agent and the recovery agent are separated from each other, for example using a filter.

According to a further embodiment, the porosity measurement is done in vacuum conditions (for example below 20 mBar, in particular below 10-2 mBar). In a preferred example, the oxygen concentration during measurement in the measurement chamber is below 100 ppm, in particular below 50 ppm, more in particular below 20 ppm, more in particular below 10 ppm.

According to a further embodiment, the apparatus is further configured to be operated in a low-pressure mode. In the low-pressure mode, a working fluid in form of a gas may be applied as a pressure-conveying medium to press the intruding agent into the pores of the sample. Pressures in the hundred bar range may be used, e.g. around 600 bar.

According to a further embodiment, a low-pressure working fluid is applied as a pressure-conveying medium to the intruding agent.

According to a further embodiment, the low-pressure working fluid comprises an inert gas or a reducing gas. This may provide the advantage that, at the same time, inert/reducing conditions are provided to the intruding agent, and the function of a working fluid is fulfilled.

According to a further embodiment, the low-pressure working fluid comprises a gas with an oxygen concentration of less than 100 ppm, in particular less than 50 ppm, in particular less than 20 ppm, more in particular less than 10 ppm. The same oxygen conditions may also be applied to the whole measurement chamber. Thereby, oxidation of the intruding agent may be efficiently prevented.

According to a further embodiment, the intruding agent is recovered using the reducing agent after the low-pressure measurement.

According to a further embodiment, the apparatus is further configured to be operated in a high-pressure mode. In the high-pressure mode, a working fluid in form of a liquid may be applied as a pressure-conveying medium to press the intruding agent into the pores of the sample. Pressures in the thousand bar range may be used, e.g. around 6000 bar.

According to a further embodiment, a high-pressure working fluid is applied as a further pressure-conveying medium to the intruding agent.

According to a further embodiment, the high-pressure working fluid comprises an inert liquid or a reducing liquid. This may provide the advantage that, at the same time, inert/reducing conditions are provided to the intruding agent, and the function of a working fluid is fulfilled.

In an example, the high-pressure working fluid is a silicon oil or a mineral oil. Such an oil may be essentially inert. Nevertheless, the high-pressure working fluid may comprise oxygen that oxidizes the gallium (alloy)).

According to a further embodiment, the reducing agent comprises a low miscibility or no miscibility with respect to the pressure working fluid, in particular the high-pressure working fluid.

According to a further embodiment wherein the reducing agent is located, in particular in the measurement chamber, between the intruding agent and the pressure working fluid, in particular the low-pressure working fluid or the high-pressure working fluid (see FIG. 6).

According to a further embodiment, at least one measurement chamber (inner) sidewall comprises a coating that is configured to prevent adhesion of gallium oxide. This may provide the advantage that sticking of gallium oxide to the sidewalls is prevented, thereby removing it more easily. In particular, the upper part of a penetrometer (stem) may be coated. In an example, this coating is especially applied in the context of high-pressure measurements. Hereby, the coating may substitute a reducing agent (measurement free of reducing agent) between the intruding agent and the high-pressure working fluid (as is e.g. shown in FIG. 6). In a specific example, the coating may comprise indium (III) oxide.

According to a further embodiment, the reducing agent is of low miscibility or no miscibility with respect to the pressure working fluid (in particular the high-pressure working fluid), thereby serving as a protection from oxidation during low/high pressure measurement. In particular, aqueous acids/bases are applied as a reducing agent together with a lipophilic pressure medium (working fluid).

According to a further embodiment, the intruding agent is recovered using the reducing agent after the high-pressure measurement. Since the high-pressure working fluid (e.g. in case of oil) may form a film on the intruding agent, said film may be removed before the recovery with a film-removing agent, e.g. an alcohol such as isopropyl.

In a specific example, reducing agent/fluid (or inert fluid) is provided between the intruding agent and the (high-pressure) working fluid (see e.g. FIG. 6). This may efficiently prevent formation of an undesired oxygen layer.

According to a further embodiment, the reducing conditions comprise an application of an exchange process to remove oxidizing agents and/or oxidized intruding agent, in particular gallium oxide, and/or reducing agent and/or reduced gallium substances from the intruding agent. This may provide the advantage that undesired species may be efficiently removed. Under specific conditions, the reducing agent may not be suitable (e.g. due to corrosion) and should then be removed. Reduced gallium substances (e.g. gallium chloride) may be undesired and could then be removed.

According to a further embodiment, the exchange process comprises at least one of a membrane, an ion exchange, an osmosis, a density separation, a filter. Thereby, establishes means may be directly applied to enable an efficient separation.

According to a further embodiment, the apparatus further comprises an oxygen sensor, configured to monitor the oxygen concentration in at least part of the apparatus, in particular the inert fluid. Since oxygen provides oxidizing conditions, which may be a main issue in the use of gallium-based intruding agents, an oxygen sensor may be applied as a versatile and advantageous monitoring tool and/or as an alarm function to keep the oxygen content as low as possible.

According to a further embodiment, the apparatus is further configured to recycle the intruding agent after the measurement, and to apply the recycled intruding agent in a further measurement. This may provide the advantage that the (recovered) intruding agent can be applied several times, thereby saving (significant) costs for buying new intruding agent and for recycling used intruding agent. As described above, the used intruding agent may be treated with reducing agent to remove oxidized substances. Furthermore, separation techniques such as a filter may be applied to remove undesired substances and/or reaction products. The recycling may be directly implemented into the described apparatus. In another example, the recycling may be done in a separate device.

According to a further embodiment, the apparatus is configured as an intrusion porosimeter. Thereby, the described approach may be directly implemented into existing (see e.g. FIG. 1) porosimeter designs. The measurement chamber may be configured as an established penetrometer.

According to a further embodiment, the pressure device is coupled to a pressure cell, in particular around the measurement chamber. Again, the described approach may be directly implemented into existing (see e.g. FIGS. 4 and 5) and tested porosimeter designs.

### BRIEF DESCRIPTION OF THE DRAWINGS

The aspects defined above and further aspects of the disclosure are apparent from the examples of embodiment to be described hereinafter and are explained with reference to these examples of embodiment.

FIG. 1 illustrates an apparatus for a porosity measurement according to an exemplary embodiment of the disclosure.

FIG. 2 illustrates an intruding agent reservoir according to an exemplary embodiment of the disclosure.

FIG. 3 illustrates an intruding agent reservoir according to a further exemplary embodiment of the disclosure.

FIG. 4 illustrates an apparatus for a porosity measurement in a low pressure mode according to an exemplary embodiment of the disclosure.

FIG. 5 illustrates an apparatus for a porosity measurement in a high pressure mode according to an exemplary embodiment of the disclosure.

FIG. 6 illustrates a measurement chamber according to an exemplary embodiment of the disclosure.

### DETAILED DESCRIPTION OF THE DRAWINGS

The illustrations in the drawings are schematic. In different drawings, similar or identical elements are provided with the same reference signs.

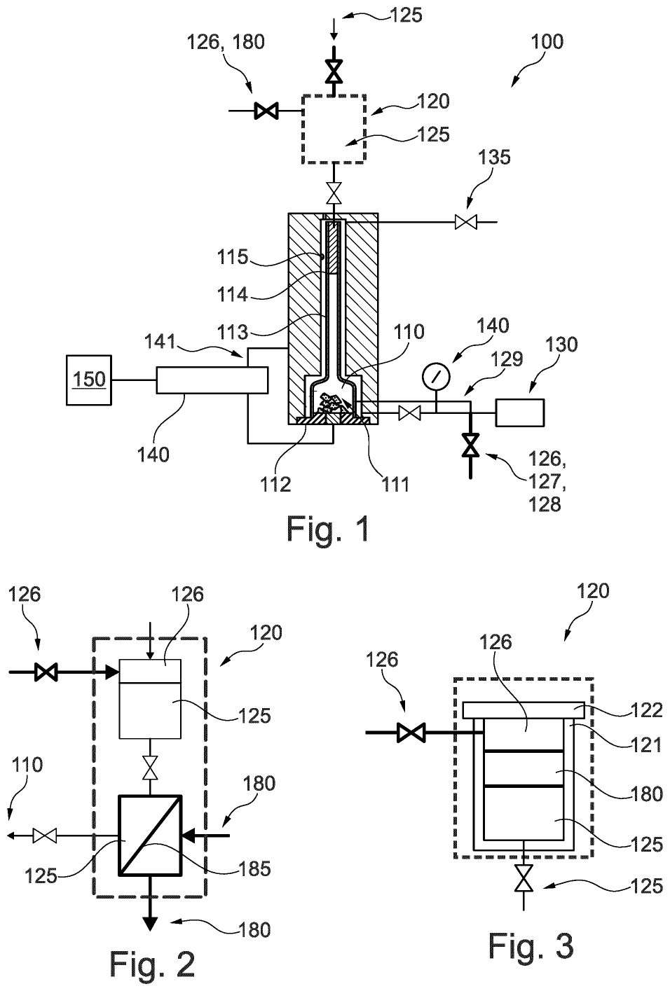

FIG. 1 illustrates an apparatus 100 for a porosity measurement according to an exemplary embodiment of the disclosure. The apparatus 100 is configured for determining an information indicative of a porosity of a sample 111 and comprises a measurement chamber 110 that accommodates the sample 111. The measurement chamber 110 is configured as a penetrometer and comprises a cavity, in which the sample 111 is placed, and a column that extends in vertical direction away from the sample 111. The sample 111 is introduced from below and is then kept in place by closure 112. The penetrometer 113 is further arranged within a pressure cell 115. A vacuum pump 135 establishes a vacuum in the measurement chamber 110.

The apparatus 100 further comprises an intruding agent reservoir 120 that stores the intruding agent 125, being gallium or a gallium alloy. In the case of gallium alone, a further heating step may be necessary (melting point 29.8° C.). The intruding agent reservoir 120 is connected to the measurement chamber 110 (in particular the column), so that the intruding agent 125 can be streamed directly from the reservoir 120 through a valve into the (column of the) measurement chamber 110. In the example shown, the intruding agent 125 already fills the measurement chamber 110 up to a meniscus 114 in the column. The intruding agent reservoir 120 is furthermore connected to a supply of intruding agent 125. The supply can be fresh intruding agent 125, recycled intruding agent 125 (from the same or a different measurement) or a mixture of both.

An inert fluid 126 (e.g. a cleaning and/or protection fluid) can be supplied to the intruding agent reservoir 120 in order to provide (chemically) inert conditions within the intruding agent reservoir 120. Specifically, the inert fluid 126 prevents that the intruding agent 120 becomes oxidized within the intruding agent reservoir 120.

Additionally or alternatively, a reducing fluid 180 can be supplied to the intruding agent reservoir 120 in order to provide (chemically) reducing conditions within the intruding agent reservoir 120. Specifically, the reducing fluid 180 prevents that the intruding agent 125 becomes oxidized within the intruding agent reservoir 120 and/or reacts with oxidized species.

The apparatus 100 further comprises a pressure device 130, configured to apply a pressure profile to the measurement chamber 110, so that the intruding agent 125 is pressed into at least part of the pores of the sample 111. In this example, the pressure device is configured as a piston connected to the pressure cell. A measurement device 140 of the apparatus 100 is coupled to the pressure device 130 and is configured to measure a pressure related to the provided pressure profile (with respect to a corresponding intruding agent volume). In this example, the measurement device 140 comprises a capacitance measurement 141 that is connected to the bottom of the measurement chamber. A drop in the intruding agent level in the capillary is recorded capacitively and thus also the exact amount of intruded gallium (alloy) volume with respect to the corresponding applied pressure.

Further, the apparatus 100 comprises a determination device 150, coupled to the measurement device 140, that configured to determine the information indicative of the porosity of the sample 111 based on the measured pressure using the Washburn equation.

Through a further supply line 129, an inert fluid 126, a reducing agent 180, a low pressure working fluid 127, and/or a high pressure working fluid 128 can be introduced into the measurement chamber 110. Each of these fluids can be configured to provide inert conditions or reducing conditions for the intruding agent 125 in the measurement chamber 110. Working fluid and cleaning fluid can be identical here, but both provide inert/reducing conditions.

The apparatus 100 is thus configured to provide reducing or inert conditions with respect to the intruding agent 125, as described above, by providing respective fluids 126, 127, 128, 180 in the measurement chamber 110 and/or in the intruding fluid reservoir 120.

FIG. 2 illustrates an intruding agent reservoir 120 (in particular from the apparatus 100 described for FIG. 1) according to an exemplary embodiment of the disclosure. In this example, the intruding agent reservoir 120 comprises two parts, the upper part being a cleaning unit, in which the intruding agent 125 is mixed with an inert cleaning fluid 126 that can be supported directly on top of the intruding agent 125. The cleaned intruding agent 125 is then streamed through a valve to the second part below. The second part comprises a membrane 185 between immiscible phases that separates the second part into an intruding agent 125 compartment and a reducing agent 180 compartment.

Each of the intruding agent 125 and the reducing agent 180 comprises a separate inlet and outlet. In this manner, intruding agent 125 can be streamed from the cleaning portion to the intruding agent 125 compartment and then further out of the reservoir 120 to the measurement cell 110. The reducing agent 180 can be streamed into the reducing agent compartment and then further out of the reservoir 120. At the membrane, the reducing agent 180 provides reducing conditions, so that oxidation of the intruding agent 180 is prevented, in particular oxidized substances are reduced.

FIG. 3 illustrates an intruding agent reservoir 120 (in particular from the apparatus 100 described for FIG. 1) according to a further exemplary embodiment of the disclosure. The reservoir 120 comprises sidewalls 121 that delimit a volume in between, and a cover 122 as a top sidewall (inert materials). At the bottom of the reservoir 120, there is located the intruding agent 125, being a gallium-based liquid. Said intruding agent 125 can be directly supplied through a valve to the measurement chamber 110 (not shown here). Above the intruding agent 125, there is located a reducing agent/fluid 180, e.g. an acid. Further, above the reducing agent 180, there is located an inert fluid 126 that can be provided through an inert fluid 126 supply line. In the present case, the inert fluid 126 is an inert gas that is present in the reservoir 120 head space and forms an inert gas blanket for the reducing agent 180 and the intruding agent 125. In this configuration, the intruding agent reservoir 120 can at the same time be a reservoir and a cleaning unit.

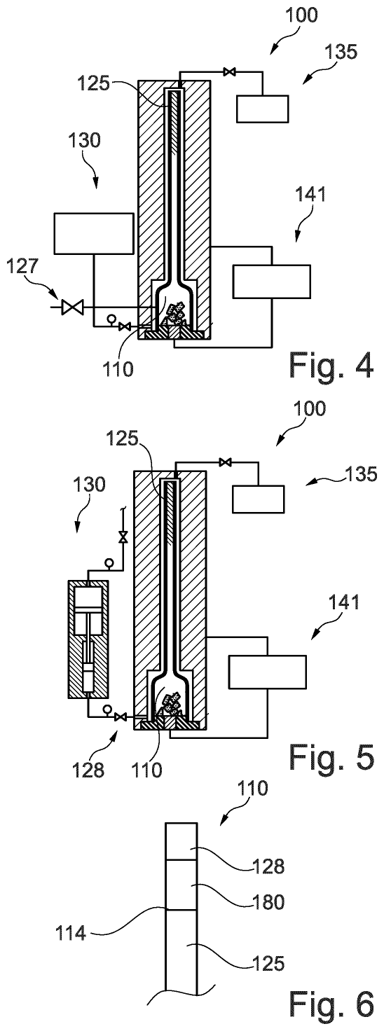

FIG. 4 illustrates an apparatus 100 for a porosity measurement in a low-pressure mode according to an exemplary embodiment of the disclosure. The apparatus 100 is very similar to the one described for FIG. 1. The pressure device 130 is configured to press a low-pressure working fluid 127 into the measurement chamber 110, so that the intruding agent 125 in the measurement chamber 110 is forced to enter the pores of the sample 111. In an example, a pressure in the hundred bar range (e.g. 600 bar) is applied. The low-pressure working fluid is preferably an inert gas such as argon or nitrogen with an extremely low oxygen content (e.g. 50 ppm or lower).

FIG. 5 illustrates an apparatus 100 for a porosity measurement in a high-pressure mode according to an exemplary embodiment of the disclosure. The apparatus 100 is very similar to the one described for FIG. 1. The pressure device 130 is configured to press a high-pressure working fluid 128 into the measurement chamber 110, so that the intruding agent 125 in the measurement chamber 110 is forced to enter the pores of the sample 111. In an example, a pressure in the thousand bar range (e.g. 6000 bar) is applied. The high-pressure working fluid 128 is preferably a liquid such as a silicon oil.

FIG. 6 illustrates (the column of) a measurement chamber 110 according to an exemplary embodiment of the disclosure. The measurement chamber 110 is configured as a penetrometer 113 and the column only is shown in FIG. 6 (compare FIG. 1). The intruding agent 125 is present in the column and can be intruded into the sample 111 below (not shown in this Figure). The intruding agent 125 fills the column up to meniscus 114. The intruding agent 125 is covered with the reducing agent 180, in this example hydrochloric acid. The reducing agent 180 is further covered by the high-pressure working fluid 128, in this example an oil. In this manner, the intruding agent 125 can be efficiently protected from oxidation during the measurement phase.

### REFERENCE NUMERALS

100 Apparatus, porosimeter
110 Measurement chamber, penetrometer
111 Sample with pores
112 Closure
113 Penetrometer
114 Meniscus
115 Pressure cell
120 Intruding agent reservoir
121 Sidewall
122 Cover
125 Intruding agent, gallium (alloy)
126 Inert fluid, cleaning fluid
127 Low pressure working fluid
128 High pressure working fluid
129 Further supply line
130 Pressure device
135 Vacuum pump
140 Measurement device
141 Capacitance measurement
150 Determination device
180 Reducing agent
185 Membrane

1.-15. (canceled)

16. An apparatus for determining an information indicative of a porosity of a sample, the apparatus comprising:
a measurement chamber, configured to accommodate the sample to be measured;
an intruding agent reservoir, configured to provide the intruding agent to the measurement chamber;
a pressure device, configured to apply a pressure profile to the measurement chamber, so that the intruding agent is pressed into at least part of the pores of the sample; and
a determination device, configured to determine the information indicative of the porosity of the sample based on the applied pressure profile and/or the volume of the intruding agent;
wherein the intruding agent comprises gallium or a gallium alloy; and
wherein the apparatus is configured to provide reducing conditions and/or inert conditions with respect to the intruding agent.

17. The apparatus according to claim 16,
wherein the gallium alloy comprises at least one metal of the group which consists of indium, tin, zinc, potassium, sodium, copper, silver, cesium, bismuth, antimony, lead, gold, thallium, palladium, platinum, selenium, lithium, cadmium,
in particular wherein the gallium alloy comprises at least one of the group which consists of GaIn, GaInSn, GaZn, GaInZn.

18. The apparatus according to claim 16, wherein the inert conditions comprise a protection of the intruding agent at least partially by an inert fluid, in particular an inert gas.

19. The apparatus according to claim 16,
wherein the reducing conditions comprise an application of a reducing agent, in particular an oxide dissolving fluid, to the intruding agent,
in particular wherein the reducing agent is applied as a fluid to a surface and/or a phase border of the intruding agent,
more in particular wherein the reducing agent comprises an acid or a base.

20. The apparatus according to claim 18,
wherein the intruding agent reservoir is configured to store the intruding agent and to provide the inert fluid and/or the reducing agent to the stored intruding agent, in particular configured to cover the surface of the stored intruding agent, more in particular so that the inert fluid and/or the reducing fluid floats on the intruding agent.

21. The apparatus according to claim 16,
wherein the determination device is further configured to determine the information indicative of the porosity of the sample using the Washburn equation.

22. The apparatus according to claim 16,
further configured to provide a cleaning fluid, in particular the inert fluid and/or the reducing agent, to at least part of the apparatus and/or to the intruding agent before the measurement and/or after the measurement, in particular within the intruding agent reservoir.

23. The apparatus according to claim 16,
further configured to be operated in a low-pressure mode, wherein a low-pressure working fluid is applied as a pressure-conveying medium to the intruding agent, in particular wherein the low-pressure working fluid comprises an inert gas or a reducing gas, more in particular a gas with an oxygen concentration of less than 100 ppm, in particular less than 50 ppm, more in particular less than 20 ppm, more in particular less than 10 ppm.

24. The apparatus according to claim 16,
further configured to be operated in a high-pressure mode, wherein a high-pressure working fluid is applied as a further pressure-conveying medium to the intruding agent, in particular wherein the high-pressure working fluid comprises an inert liquid, more in particular a silicon oil or a mineral oil.

25. The apparatus according to claim 23,
wherein the reducing agent comprises a low miscibility or no miscibility with respect to the pressure working fluid, in particular the high-pressure working fluid; and/or
wherein the reducing agent is located, in particular in the measurement chamber, between the intruding agent and the pressure working fluid, in particular the low-pressure working fluid or the high-pressure working fluid.

26. The apparatus according to claim 16, further comprising:
an oxygen sensor, configured to monitor the oxygen concentration in at least part of the apparatus, in particular of the inert fluid.

27. The apparatus according to claim 16,
further configured to recycle the intruding agent after the measurement, and to apply the recycled intruding agent in a further measurement.

28. The apparatus according to claim 16,
wherein the apparatus is configured as an intrusion porosimeter.

29. The apparatus according to claim 16,
wherein the measurement chamber comprises a penetrometer.

30. The apparatus according to claim 16,
wherein at least one measurement chamber sidewall comprises a coating that is configured to prevent adhesion of metal oxide, in particular gallium oxide.

31. The apparatus according to claim 16,
wherein the reducing conditions comprise an application of an exchange process to remove oxidizing agents and/or oxidized intruding agent, in particular gallium oxide, from the intruding agent,
in particular wherein the exchange process comprises at least one of a membrane, an ion exchange, an osmosis, a density separation, a filter.

32. A method of determining an information indicative of a porosity of a sample, the method comprising:
providing an intruding agent to the sample to be measured, wherein the intruding agent comprises gallium or a gallium alloy;
applying a pressure profile, so that the intruding agent is pressed into at least a part of the pores of the sample;
determining the information indicative of the porosity of the sample based on the applied pressure profile and/or the volume of the intruding agent; and
wherein the method further comprises:
providing reducing conditions and/or inert conditions with respect to the intruding agent.
